(19) United States
(12) Patent Application Publication
(10) Pub. No.: US 2007/0082109 A1
(43) Pub. Date: Apr. 12, 2007

(54) Slowly digestible starch-containing foodstuffs

(76) Inventors: Rolf Muller, Zurich (CH); Federico Innerebner, Zurich (CH)

Correspondence Address: BACHMAN & LAPOINTE, P.C., 900 CHAPEL STREET, SUITE 1201, NEW HAVEN, CT, 06510, US

(21) Appl. No.: 10/583,835

(22) PCT Filed: Dec. 17, 2004
(86) PCT No.: PCT/CH04/00744

§ 371 Date: Jun. 19, 2006

(30) Foreign Application Priority Data
Dec. 18, 2003 (DE) 103 59 918.5

(51) Int. Cl. A23L 1/05

(52) U.S. Cl. 426/578

(57) ABSTRACT

The invention relates to slowly digestible starch-containing foodstuffs, such as cereals and snacks, while a substantial percentage of the starch phase of starch-containing foodstuffs is transformed into a slowly digestible form in situ during foodstuff manufacture by modifying the method typical for the respective foodstuff, and if necessary, the recipe. During the manufacture of starch-containing foodstuffs, the starch is most often prepared to the extent where it digested exceedingly quickly, and converted into glucose in the process. This leads to a rapid rise in the blood sugar level (high sugar), followed by a speedy to severe drop in the blood sugar level (low sugar). These foodstuffs have a high glycemic index (GI). A high number of more recent studies suggest that foodstuffs with a high GI are a significant cause of diabetes, obesity and cardiopulmonary diseases. The WHO believes that indicating GI values on foodstuff packaging would effectively help in preventing the mentioned diseases. Therefore, there is a need for starch-containing foodstuffs that have a reduced GI, i.e., are slowly digested. Within this context, the ideal scenario involves a foodstuff with a constant hydrolysis over time, wherein precisely the amount of glucose consumed for metabolism is released per unit of time. Such a foodstuff would be exceedingly desirable in particular for diabetics. The best currently existing solution for diabetics in this regard is uncooked, i.e., native corn starch (WO 95/24906), which is digested relatively slowly. However, the consumption of native cornstarch in the form of an aqueous slurry is unattractive on the one hand, and only a limited time-constant release of glucose can here be achieved on the other. In addition, the temperature stability of native cornstarch is limited, so that only very limited incorporation in processable foodstuff preparations is possible. Other forms of slowly digestible starches include resistant starches (e.g., high corn, Novelose, ActiStar, CrystaLean). These starches exhibit a high crystalline percentage, and about 50% can be digested in the small intestine. The remainder is fermented in the large intestine. The percentage that can be digested in the small intestine is predominantly digested very quickly, so that it makes sense to use only a limited amount of resistant starches as food additives for reducing the GI. Other slowly digestible starches are described in WO 2004/066955 A2. These starches are obtained by gelatinizing a suspension of about 5% starch in water,

### BACKGROUND OF THE INVENTION

The invention relates to slowly digestible starch-containing foodstuffs, such as cereals and snacks,while a substantial percentage of the starch phase of starch-containing foodstuffs is transformed into a slowly digestible form in situ during foodstuff manufacture by modifying the method typical for the respective foodstuff, and if necessary, the recipe.

During the manufacture of starch-containing foodstuffs, the starch is most often prepared to the extent where it digested exceedingly quickly, and converted into glucose in the process. This leads to a rapid rise in the blood sugar level (high sugar), followed by a speedy to severe drop in the blood sugar level (low sugar). These foodstuffs have a high glycemic index (GI). A high number of more recent studies suggest that foodstuffs with a high GI are a significant cause of diabetes, obesity and cardiopulmonary diseases. The WHO believes that indicating GI values on foodstuff packaging would effectively help in preventing the mentioned diseases. Therefore, there is a need for starch-containing foodstuffs that have a reduced GI, i.e., are slowly digested. Within this context, the ideal scenario involves a foodstuff with a constant hydrolysis over time, wherein precisely the amount of glucose consumed for metabolism is released per unit of time. Such a foodstuff would be exceedingly desirable in particular for diabetics. The best currently existing solution for diabetics in this regard is uncooked, i.e., native corn starch (WO 95/24906), which is digested relatively slowly. However, the consumption of native cornstarch in the form of an aqueous slurry is unattractive on the one hand, and only a limited time-constant release of glucose can here be achieved on the other. In addition, the temperature stability of native cornstarch is limited, so that only very limited incorporation in processable foodstuff preparations is possible. Other forms of slowly digestible starches include resistant starches (e.g., high corn, Novelose, ActiStar, CrystaLean). These starches exhibit a high crystalline percentage, and about 50% can be digested in the small intestine. The remainder is fermented in the large intestine. The percentage that can be digested in the small intestine is predominantly digested very quickly, so that it makes sense to use only a limited amount of resistant starches as food additives for reducing the GI.

Other slowly digestible starches are described in WO 2004/066955 A2. These starches are obtained by gelatinizing a suspension of about 5% starch in water, and treating it with alpha amylase. The starch is then precipitated, making it possible to obtain a high crystalline percentage of it. According to the disclosure, the digestive action of these starches ranges between resistant starches and untreated, native starch.

Other slowly digestible starches are described in US 2003/0219520 A1 and US 2003/0215562 A1. Starches with a low amylose content or higher amylose content are here also gelatinized, and debranched up to at least 90% with debranched enzymes (isoamylase, pullulanase) at water contents exceeding 70%. The starches are then precipitated and obtained with a high crystalline percentage, which reduces the rate of digestion. The digestive behavior of these starches also ranges between resistant starches and untreated, native starches.

### SUMMARY OF THE INVENTION

As opposed to existing solutions for reducing the hydrolysis rate or GI via slowly digestible ingredients, the object of this invention is to transform a substantial percentage of the starch phase of starch-containing foodstuffs into a slowly digestible form during the manufacture of the foodstuff by modifying the methods typical for the respective foodstuff, and if necessary the recipes. This solution is referred to as in situ technology.

By transforming the starch phase as a whole into a slowly digestible form, a significantly higher reduction in the GI can be achieved in comparison to the addition of low GI ingredients into a high GI phase, and organoleptic properties, such as crispiness, are improved as well. This makes the in situ technology attractive in both respects.

The invention relates to a slowly digestible, starch-containing foodstuff with a hydrolysis rate that can be set within broad limits using methods involving recipe and methods. In particular, it was surprisingly discovered that the foodstuff can be obtained with a low and, if necessary, constant hydrolysis rate, thereby enabling a long-lasting, constant release of glucose. As a result, the blood sugar level can be favorably affected, both high sugar and low sugar are avoided, and glucose can be supplied as a form of long-lasting energy.

These advantageous properties of the foodstuff are obtained by at least partially gelatinizing or at least partially plasticizing the starch of the foodstuff in a first step. The partially crystalline structure of the starch grain is here transformed into an amorphous structure during the gelatinizing process, wherein the grain is retained as an entity, while also disappearing during plasticization. This is followed by a conditioning process, during which a network or gel recrystallizes and forms. A partially crystalline structure is here built up once again, but as opposed to the partially crystalline structure of native starch, it can be specifically adjusted to the relevant parameters, and has higher temperature stability. It was discovered that as the extent of network formation expands, e.g., network density rises, the level of amylase inhibition, and hence the hydrolyzation rate reduction level, both increase as well. It was found that particularly advantageous structures are obtained through the use of short-chain amylose (SCA), wherein the rate at which these structures form can also be massively accelerated. Owing to the formed network, the foodstuff has limited swellability, thereby limiting the entry of the hydrolyzing amylases during digestion. This yields a massively reduced digestion rate as compared to the amorphous state, which results in a very rapid hydrolyzation. The crystallites that form the linking points in the network are slowly digestible to indigestible. The portion that cannot be digested in the small intestine is here present in the form of resistant starch (RS). The digestible portion of the crystallites and the amorphous phase with limited swellability are present in the form of advantageous, slowly digestible starch, which comprises the bulk of the foodstuff. The ratio between slowly digestible starch and RS can be set using the network parameters, wherein a very high portion of slowly digestible starch at a small portion of RS can be obtained in particular, and the foodstuff can be obtained without a portion of rapidly digestible starch. As a whole, then, any hydrolysis rates ranging from the very rapid and disadvantageous hydrolysis of amorphous starch of the kind encountered for most prepared starch-containing foodstuffs to the minimal hydrolysis rate.

The difference relative to WO 2004/066955 A2, US 2003/0219520 A1 and US 2003/0215562 A1 lies primarily in the fact that the hydrolysis characteristics are set using the parameters for the network with a limited degree of swelling, which requires a small crystalline percentage in the form of the crystallites linking the network (about 1-50%), while the crystallites (about 40-70%) are primarily not linked together after precipitation in the cited patent applications, and the hydrolysis characteristics are determined by the varying degree of crystallite perfection (slowly digestible portion) and a portion of freely accessible, amorphous starch (rapidly digestible portion). Since the starch networks extend over the entire starch phase or a substantial portion thereof, and arise during the manufacture of the foodstuff, the starch networks are regarded as in situ networks, and the concomitant reduction in GI as in situ GI reduction. This provides a clear delineation between possible ways of reducing the GI by adding slowly digestible ingredients.

During the manufacture of starch-containing foodstuffs, the starch portion is mostly digested entirely, during which it is transformed from the partially crystalline state into a practically completely amorphous state. The conditions for further processing enable at most minimal recrystallization, so that the starch phase of the foodstuff is then digested at a rate close to the hydrolysis rate of amorphous starch. The latter measures about 100%/h under in vitro conditions, while starch-based foodstuffs like Corn Flakes, snacks, cookies, potato chips, French fried chips, French fries or Pringles are hydrolyzed in vitro at hydrolysis rates ranging from 800 to 1000%/h.

The conditioning units currently used for processing foodstuffs are rooted in process engineering, or used with respect to texture properties, and are not suited for reducing the GI or hydrolysis rate of the foodstuff. In a narrower sense, then, the invention relates to the incorporation of additional procedural steps and/or the modification of existing procedural steps, and to the provision of suitable specific process or conditioning parameters, making it possible to use more efficient methods to generate starch networks that permit a clear reduction in the GI of the foodstuff. Since starch is typically very slow to crystallize, another aspect of the invention involves establishing conditions under which this process essential for network formation can be accelerated. The temperature stability of the crystallites linking the network is of importance on the one hand in cases where the network is generated in a phase during the manufacture of the foodstuff, and high temperatures are subsequently used, or in a baking, toasting, blistering or drying process. On the other hand, temperature stability is important if the foodstuff is subjected to high temperatures and water contents prior to consumption, e.g., cooking or heating. For these reasons, the method used to reduce the hydrolysis rate or GI for the various groups of methods for manufacturing starch-containing foodstuffs must be adjusted to the conditions existing in the process, and in a narrower sense relates to the respectively modified methods.

To this end, the methods are divided into the following basic process units: Preparation, wherein at least the basic recipe components are mixed together, and wherein in particular at least one substantial digestion of the starch takes place (e.g., cooking extrusion); molding and intermediate steps, wherein at least the most important molding parameters are partially established (e.g., hot cutting and expansion), and necessary conditioning operations are performed (e.g., equilibration of the water content or relaxations); post-treatment, during which final properties like water content, texture, color and taste are determined, and which can be followed by packaging (e.g., toasting, drying, glazing, spraying, etc.). In most methods for manufacturing starch-containing foodstuffs, these basic process units can be differentiated, wherein one such process unit can encompass different procedural steps, and the process units can also partially overlap. The conditioning processes used to obtain advantageous starch network can be performed before and/or during and/or after molding, and/or during and/or after post-treatment, and are advantageously tailored to the respective conditions.

### BRIEF DESCRIPTION OF THE DRAWINGS

FIG. 1 shows hydrolysis curves for slowly digestible corn flakes;

FIG. 2 shows hydrolysis curves for slowly digestible potato snacks;

FIG. 3 shows hydrolysis curves for slowly digestible corn chips; and

FIG. 4 shows correlation between the initial hydrolysis rate Ho and the glycemic index (GI).

### DETAILED DESCRIPTION

Basic Starch

Slowly digestible starch-containing foodstuffs can be manufactured proceeding from any starch (basic starch) or mixtures of starches, such as corn, wheat, potato, tapioca, rice, sago, pea starch, etc.. Starch is here understood to mean both starch in the narrower sense, along with flours and semolina. The starch can be chemically, enzymatically, physically or genetically altered. The amylose content in the starch can range from 0% (waxy starches) up to nearly 100% (high-amylose-containing starches). Starches with good crystallization properties are preferred. These include starches, their amlyopectin A side chains with a chain length >10, preferably >12, most preferably >14, and/or starches with an amylose content >20, preferably >30, most preferably >50 and/or starches that were altered to yield improved crystallization properties, e.g., starches hydrolyzed with acid and/or enzymatically, such as thin-cooking starches or partially debranched starches. The starches can be in a non-gelatinized state, partially to completely gelatinized, or partially to completely plasticized. Since the starch used in most starch-containing foodstuffs is prescribed within certain limits, the preferred starches must be viewed in such a way that, whenever possible, the corresponding starches are preferably used, or added as part of a recipe modification.

Short-Chain Amylose (SCA)

The additional use of short-chain amylose (SCA) with a polymerization level of <300, preferably <100, more preferably <70, most preferably <50 is of advantage. SCA can be obtained, for example, from amylose by adding amylases, or from amylopectin through the use of debranched enzymes, such as isoamylase or pullulanase. The use of SCA makes it possible to obtain especially advantageous, slowly digestible, starch-containing foodstuffs, and in particular enables the clearly accelerated formation of advantageous networks, thereby simplifying the method and making it more cost effective. Thermostability is also increased. The SCA here works in such a way as to induce the crystallinity of the basic starch on the one hand by forming mixed crystallites, and increase the network density on the other, thereby reducing the swellability, and hence the hydrolysis rate. As molecularly disperse a mixture of basic starch and SCA as possible is crucial to realize these advantages. This is achieved by mixing the SCA in with the at least partially gelatinized basic starch, e.g., in the form of a solution, or by adding the SCA in an amorphous state, e.g., in a spray dried form, or by adding the SCA in partially crystalline form, and then digesting it while preparing the basic starch, or by directly obtaining the SCA directly from the basic starch using debranched enzymes during the preparation of the basic starch. Similar advantages are realized when treating the basic starch with further amylases, such as alpha amylase. This reduces the molecular weight and improves crystallizability. In addition, networks can also be obtained when using SCA even under conditions where no networks would come about without SCA, e.g., at low water contents and low temperatures, when the basic starch is present in an amorphous, quasi-frozen state. Advantageous percentages of SCA relative to the entire starch in % w/w range from 1-95, preferably 2-70, more preferably 3-60, most preferably 4-50.

In order to manufacture slowly digestible starch-containing foodstuffs, the basic starch is set to an at least partially gelatinized or at least partially plasticized state in a first step. It is advantageous that the SCA in this state be as molecularly disperse in the basic starch as possible. This is achieved using known cooking and mixing methods. It is especially advantageous for preparation to take place via extrusion.

Network formation is initiated via conditioning from the prepared state, wherein the starch is present at least partially in an amorphous state, thereby transforming the starch into a slowly digestible form. In this case, the conditioning parameters are important for enabling the formation of advantageous networks, and for the extent of hydrolysis rate reduction. These parameters depend on the recipe (type of basic starch, if necessary a portion of SCA). It was found relative to the advantageous parameters that roughly the following general conditions apply: Water content Wo in % w/w during conditioning ranges from 10-90, preferably 14-70, more preferably 16-60, most preferably 18-50. As water content decreases, more tightly meshed networks characterized by a low swelling degree Q are obtained, which are advantageous for hydrolysis rate reduction. Also advantageous are lower water contents, because the end product most often exhibits a water content <30%, so that less process water must again be removed.

With respect to a reference temperature To, difference Tk-To in ° C. ranges from 20-150, preferably 35-135, more preferably 50-120, most preferably 70-100, wherein the following correlation applies between To and Wo:

TABLE 1

| Wo | % | 10 | 15 | 20 | 25 | 30 | 35 | 40 | 45 | 50 | 55 | 60 | 65 | 70 | 80 | 90 |
|---|---|---|---|---|---|---|---|---|---|---|---|---|---|---|---|---|
| To | ° C. | 98 | 55 | 23 | −3 | — | — | — | — | — | — | — | — | — | — | — |
| | | | | | | 24 | 41 | 55 | 67 | 78 | 87 | 95 | 102 | 108 | 119 | 128 |

The interpolated values for To apply with respect to water contents Wo between the specified values. If the lower limits of Tk lie at temperatures <<0° C. based on the advantageous temperature intervals, the lower limit for Tk is the temperature just over the freezing point of the starch-water mixture (approx. −10° C.). Higher temperatures Tk are advantageously used with decreasing water content Wo.

The conditioning time tw in h ranges from 0-24, preferably 0.1-12, more preferably 0.25-6, most preferably 0.5-3. A conditioning time of Oh here means that no special conditioning is performed here, and the desired reduction in GI is achieved by modifying existing process windows and/or by adding SCA. Of course, conditioning times >24 h can also be used, and the specified advantageous ranges relate to economically optimized methods, wherein the shortest possible process times are advantageous.

When using SCA, it is advantageous to use the higher temperatures tk, lower water contents Wo and shorter times tk, while conditions are reversed when SCA is not used. The conditioning parameters Wo and Tk can also exhibit a timed progression, and it is particularly advantageous to combine conditioning with a drying process, so that the process can be simplified and economically optimized.

Selecting the suitable conditioning parameters is important to obtain big effects, i.e., pronounced reductions in the hydrolysis rate Ho, as fast as possible. For example, when using SCA in a water content range of about 20-35%, conditioning at 50° C. for a half an hour makes it possible to achieve the same reduction in the hydrolysis rate Ho as would result for recipes without SCA in a water content range of about 30-50% via conditioning at 25° C. for 24 h. High thermostability is obtained given a high percentage of amylose and/or during conditioning processes performed at high temperatures.

The conditions for specific methods will be explained below, making it possible to obtain reduced digestion rates. For example, this illustrates how processes should be modified with an eye toward reducing the digestion rate. The strategies and methods disclosed in the process can generally also be applied to methods not explicitly described here.

Pellet-to-Flakes Extrusion Cooking (PFEC)

The PFEC method typically involves the manufacture of cereal flakes. Basically the same recipes and processes common for conventional production processes can basically be used. By contrast, several critical process parameters are adjusted for setting slowly digestible variants. In a first step, the recipe components are traditionally prepared via extrusion cooking, wherein the starch is practically completely digested. Within the scope of the invention, a partial digestion ranging from 60-99% is advantageous. The undigested structures can enhance the conditioning effect during ensuing conditioning processes for generating networks. It is advantageous for the SCA to be molecularly dispersed in the starch at the end of extrusion. Pellets are obtained via hot cutting at the die. The water content Wo of the pellets in % w/w advantageously ranges from 15-40, preferably 18-35, more preferably 19-30, most preferably 20-25. Conditioning can be performed within these water content ranges, which can distinctly reduce the hydrolysis rate. The conditioning temperature Tk as a function of Wo is derived from Table 1 and the specified intervals for Tk-To. At Wo=25%, To˜ −3° C., while Tk in ° C. ranges from 17-147, preferably 32-132, more preferably 47-117, most preferably 67-97. The information about preferred conditioning times tk can also be gleaned from the data regarding the generally preferred conditioning conditions. The high conditioning temperatures of the general conditioning conditions are particularly preferred, since thermally more stable crystallites are then formed, which can make it through the subsequent procedural steps, which involve the use of high temperatures. This conditioning phase is also used in conventional methods as required to equilibrate the water content of the pellets. However, the parameters are not later optimized (water content too low, temperatures too low, time too short) for obtaining advantageous networks in terms of the invention. However, the traditional conditions are sufficient for obtaining at least moderate reduction in the hydrolysis rate, at least in recipes that have SCA.

In the ensuing flaking process, the pellets are shaped into flakes at temperatures ranging from about 40-60° C. In the next step, the flakes are dried in an oven. Under the usual conditions, the water contents range from 18-20%, and the furnace temperatures between about 220-300° C. at the beginning of the drying process. Previously established networks are largely destroyed under these conditions. This procedural step can nonetheless be advantageously used to perform a subsequent conditioning process to reduce the hydrolysis rate and obtain previously set networks. This is achieved by drying at lower temperatures at a slowed rate. The relation between the oven temperatures Tk as a function of water content Wo while drying is advantageously characterized in that Tk-To in ° C. ranges from 50-120, more preferably from 70-100, wherein To as a function of the water content Wo can be derived from Table 1. As a result, existing networks are not damaged, and the network density can be further increased. The conditioning or drying times correspond to the drying times specified in the general conditioning conditions. After the drying process, when the final water content in % w/w ranges from about 7-13, preferably from 9-11, toasting takes place, wherein a puffed structure can be set, and both the taste and color are established. The oven temperatures in ° C. here range from 160-300, preferably 180-260, most preferably 190-240. In the puffing process, the network density is steadily reduced with increasing temperature, so that the lowest possible temperatures are advantageously used. This effect can also be minimized with especially stable crystallites, by using SCA and/or starches with an amylose content in % >30, preferably >50. Puffing need not necessarily take place. Maximum reductions in the hydrolysis rates of <<200%/h, e.g., 20%/h, are obtained by setting the oven temperatures below the puffing temperature. Such flakes are also attractive, and particularly suitable for diabetics.

In one variant of the PFEC, the pellets can be replaced after extrusion by directly cutting flakes, which are then baked and/or puffed. The conditioning conditions specified for the PFEC methods can also be applied to this variant in similar fashion. This makes it possible to obtain slowly digestible chips, for example.

Direct-Expansion Extrusion-Cooking (DEEC)

In the DEEC method, puffed cereals and snacks are manufactured, wherein puffing directly follows extrusion. Essentially the same recipes and procedural steps that are traditionally the norm can again be used to modify this method for reducing the hydrolysis rate. Here as well, it is advantageous for digestion not to be complete, as opposed to the standard method. After puffing, the water content typically ranges from 7-10%. Higher water contents are advantageous in terms of the invention, in particular water contents in % ranging from 8-30, preferably 10-25, more preferably 12-22, most preferably 13-20. This can be achieved on the one hand by increasing the water content during extrusion and/or elevating the water content after puffing or conditioning at a corresponding atmospheric humidity. The higher water contents by comparison to the standard method are advantageous for obtaining high network densities in a subsequent conditioning process. The relationship between the conditioning temperature Tk as a function of the water content Wo during conditioning is advantageously characterized in that Tk-To in ° C. ranges from 50-120, more preferably 70-100, wherein To as a function of water content Wo can be gleaned from Table 1. The conditioning or drying times correspond to the drying times specified in the general conditioning conditions. In the standard methods, drying follows the puffing process. This process can be modified according to the information available, and used for conditioning purposes.

Flaking from Flaking Grits

In this traditional method, coarse flaking grits are used to shape flakes after cooking and several partial heating stages, which are then processed further in a similar manner as the flakes molded into pellets in the PFEC method. Given the similarity between the methods, the conditions for establishing advantageous networks specified for the PFEC can also be similarly applied to this method. However, one essential difference involves the variant with recipes having SCA. Since one flake ends up being fabricated from a respective flaking grit, the SCA cannot be added in a mixing process. However, an aqueous solution of SCA can be added in the batch cooking process, in which the flaking grits are cooked and gelatinized for about 1 h, thereby allowing the SCA to diffuse into the grits, so that a molecularly disperse mixture of SCA with the basic starch can also be set. In another variant, debranched enzymes are used, so that the SCA is formed at the correct location directly from the grit starch. The partial debranching can take place before or during an initial phase of batch cooking or thereafter, e.g., by spraying an enzyme solution on the cooked grits.

Baking Procedures

The general conditioning principles can also be applied to various baking procedures in order to obtain slowly digestible products. Since the water content Wo tapers off in the baking process in most instances, the conditioning processes must be variably related to the respectively current water content Wo in terms of time. Particular mention is here made of baking procedures in which high water contents Wo are used, e.g., while baking extruded chips or Pringles, which have a water content >30% at the start of baking. In these cases, it is very difficult to retain previously set networks. However, advantageous networks can be obtained if the oven temperature is reduced to the temperature range of relevance based on the general conditioning conditions for Tk at Wo during the course of reducing the water content while baking at a water content Wo <30%. At Wo=15%, this temperature range most preferably ranges from 125-155° C. This means that the products are completely baked at a correspondingly reduced oven temperature. This approach can be used for baked goods having a water content of about 20% at the end of the baking process. Even in this product group, the effect can be enhanced and produced more quickly with a percentage of SCA.

When baking bread, the final water content typically ranges form 40-50%. At the usual temperatures in the bread while baking, a network cannot be formed. However, the use of SCA makes it possible to create a network during cooling and storage, most preferably at 3-33° C. (for Wo=45%), i.e., in the room temperature range, within 20-60 min, thereby distinctly reducing the GI of the crumbs. The crust can already form a network in the baking process, since the water content is here far lower. Also obtained as a result is an enhanced crispiness and longer lasting freshness, i.e., the crust remains crispy longer when moisture is absorbed from the atmosphere or the crumbs. For example, SCA can be used by adding a aqueous solution of SCA while manufacturing the dough, or by adding a solution of debranched enzymes that provided the SCA on site from the flour when the dough rises.

Properties

Starch networks generated in situ make it possible to set the digestion rate within a wide range, and in particular to reduce it relative to a similar starch-containing foodstuff manufactured through conventional means. The initial in vitro hydrolysis rate Ho is directly correlated with the GI (see FIG. 4), but is much more easily and precisely determinable, so that this variable will here be used to describe the digestive behavior. With respect to the matter of GI values obtained form in vivo experiments, reference is made to Am J Clin Nutr 2002; 76:5-56 (International table of glycemic index and glycemic load values: 2002, page 6: Why do GI values for the same types of food sometimes vary).

The degree of Ho reduction in % measures >10, preferably >20, more preferably >30, most preferably >50. In the case of Corn Flakes, for example, an Ho recipe comparable to classic Corn Flakes in %/h of 800, 600, 380, 320 and 190 could be set (see Table 2, No. 57-4, 58-1 to 58-4), while conventional, classic Corn Flakes exhibit a value of 900, so that the achieved reduction in % measured 11, 33, 58, 64 and even 79%. The different types of available Corn Flakes also include product that have an Ho of <900 %/h, e.g., whole grain Corn Flakes have a value of about 750%/h. The use of in situ technology makes it possible to reduce Ho for this type as well, wherein 750%/h then applies as the comparative variable for Ho reduction. This is also intended to illustrate how the term “similar starch-containing foodstuff” is to be interpreted. In most cases, this refers to a similar recipe, and a similarity with respect to the method is also understood here, wherein the variations typical for the in situ technology with regard to recipe (in particular the use of SCA) and methods are understood as encompassed by the analogy.

A respective increase in the percentage of resistant starch is associated with the level of Ho reduction. The share of these resistant starches generated by the crystallites in % preferably ranges from 1-25, more preferably from 2-20, most preferably from 3-15.

The Ho is advantageously reduced by using a portion of SCA and executing a specific conditioning process to generate advantageous starch networks. However, this is not mandatory. A sufficient reduction in Ho can already be obtained even without a portion of SCA given suitable conditioning on the one hand, and advantageous networks can come about under the conventional process conditions when using SCA even without specific conditioning processes.

A phase in which the hydrolysis rate is constant for as long as possible is particularly advantageous. This corresponds to a constant supply of glucose for the body over time. The starch-containing foodstuffs according to the invention advantageously have a constant or nearly constant hydrolysis rate in %/h of <600, preferably <450, more preferably <300, most preferably <150. The duration of the constant hydrolysis rate in min here lies at >10, preferably >15, more preferably >20, most preferably >30. For example, a constant hydrolysis rate of about 110%/h for 30 min was obtained in vitro on FIG. 1 for the recipe WS 77-1. The time scale is expanded by a factor of about 5-8 in vivo by comparison to in vitro, so that the specified times in vivo reflect a significant time span for which a constant supply of glucose takes place for the organism.

The generation of starch networks is associated with the reduction in the swelling level of the starch phase, which complicates the entry of amylases during digestion. Advantageous swelling levels Q range from 1.1-5, preferably 1.2-4.5, more preferably 1.25-3, most preferably 1.27-2.

One important property of the generated starch network is the melting point for the crystallite linking the network, in particular when the network is generated during manufacture, and exposure to strong thermal loads takes place thereafter, or when the foodstuff is exposed to a thermal load prior to consumption. The stability of the crystallites can be ensured given a thermal load during manufacture if the temperature is within the temperature ranges specified in the general conditioning conditions at a specific water content Wo. The higher the melting point of the crystallites, the higher the thermal load can be without damaging the network. At high melting points, the ranges can even be exceeded at the top. The melting point of the crystallites in ° C. is best determined via DSC, and advantageously measures >60, preferably >70, more preferably >80, most preferably >909. High melting points are used at high conditioning temperatures, during the application of SCA, wherein the thermostability increases with the polymerization level DP up to DP values of around 300, and while utilizing basic starches with preferred amylose contents.

In the case of crispy foodstuffs like puffed flakes and snacks, the crispiness level is a very important property. During the manufacture of Corn Flakes, the more recent continuous extrusion processes are significantly easier and less expensive than the traditional batch cooking method, in which flaking grits are used. Nonetheless, the batch cooking method is still often used today, because the crispiness is here more pronounced. Comparative organoleptic tests found that established starch networks distinctly improve crispiness. This can be attributed to the presence of the crystallites on the one hand, while the network also slows the absorption of water on the other, so that the crispiness can be both enhanced and prolonged, e.g., Corn Flakes with established networks remain crispy in milk longer. The situation is similar during the absorption of water from the atmosphere. For this reason, starch-containing foodstuffs that were modified with starch networks to reduce the digestive rate and exhibit crispiness have an improved, longer lasting crispiness that drops less sharply during the absorption of water. For example, this makes it possible to obtain Corn Flakes via extrusion that exhibit identical and even better crispiness properties as opposed to poorer crispiness properties.

Applications

The in situ technology in all its variants can basically be used for any starch-containing foodstuffs. The following enumeration is not to be regarded as limiting, and cites the most important product groups and products that can be obtained with the in situ technology as analogous, slowly digestible foodstuffs: Flaked and puffed cereals like Corn Flakes, multigrain flakes, high-fiber flakes, crisp rice, etc., snacks and crisps like chips, in particular potato, corn and Mexican chips (tortilla chips), potato sticks and rings, etc., baked snacks, more narrowly starch-based snacks, Masa snacks, deep-fried snacks; biscuits, crackers, zwieback, bread, flaked and granulated potato, animal food, in particular pet food. Crispiness is an important product property in most of these products, and can also be improved using the in situ technology.

### EXAMPLE 1

This example for the production of slowly digestible Corn Flakes is intended to illustrate the use of in situ technology for the pellet-to-flakes extrusion-cooking (PFEC) process. The recipes WS 77-0 to WS 77-2, WS 78-0 and WS 78-1 (compare Table 2) consisting of 91 % corn flour, 7.4% sugar, 1.4% salt and 0.2% malt in a dry state were plasticized at a water content of 31 %, a speed of 110 RPM and mass temperature of up to 105° C. for 6-8 min in a Brabender kneader with a 50 ml kneading chamber. In SCA-containing recipes in which a portion of the corn meal was replaced by SCA, the SCA was added in a spray-dried state. The homogenized kneading mass was pressed into films 0.25 mm thick in a press. These films with water contents Wo were conditioned according to the data in Table 2 by being wrapped in saran wrap and stored for 30 min at 75 to 85° C. The films were then cut into flakes, which were puffed and toasted as necessary (10% water content, 240° C., 45 s). FIG. 1 shows the hydrolysis curves for the obtained Corn Flakes in comparison with reference curves for traditional Kellogg's Corn Flakes (batch cooking process, similar recipe, a very similar curve was obtained for extruded Corn Flakes, with only a slightly higher Ho), whole grain bread, pumpernickel or rye whole grain bread, and native cornstarch. The curve for WS 77-0 reflects the state of the flakes after conditioning and before puffing and toasting. This state has an Ho of only 76%, and the hydrolysis curve only lies slightly above the curve for native cornstarch. After puffing and toasting, Ho increases to a value of 180%/h (WS 77-1). This is still a much lower value than the value of about 900/% for Kellogg's Corn Flakes. The increase in Ho is rooted in the puffed, fine cellular structure of the flakes, which shortens the diffusion paths for the enzymes. If the oven temperature is lowered somewhat to preclude the puff effect, while still allowing baking, the rise in Ho relative to WS 77-0 is only half as great as for WS 77-1. The state of WS 77-0 was taken as the starting point for WS 77-2 as well, but the water content while puffing and toasting was initially 2% higher. In this case, this enabled a partial melting of the crystallites, thereby reducing the network density. However, the value of Ho for this product is still very low at about 300% in comparison with the similar conventional product. In order to achieve the same reduction with a low-GI ingredient having a very low value for Ho of 20%/h, the share of the ingredient would have to measure about 60%. This example clearly shows the advantage of reducing the GI via in situ technology by comparison to the use of a low-GI ingredient. The situation is similar for curves WS 78-0 and WS 78-1 as it is for WS 77-0 and WS 77-1, the difference being only half as much of a percentage of SCA and somewhat modified conditioning condition. Reduction for the puffed sample WS 78-1 is still large, and the value for Ho at 480%/h is somewhat less than the value for whole grain bread (530%/h), and clearly exceeds the value for whole grain Corn Flakes (about 750%/h).

### EXAMPLE 2

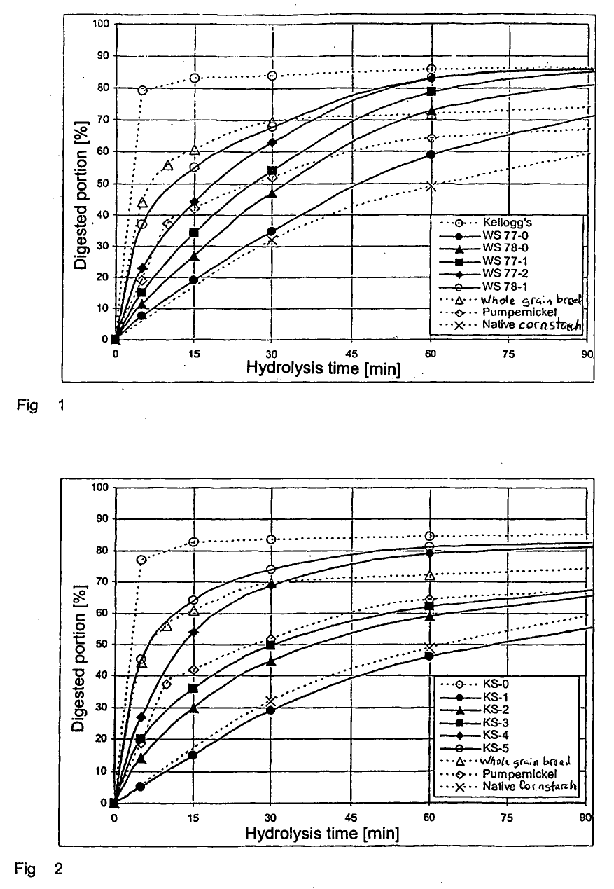

This example for the production of slowly digestible potato snacks is intended to illustrate the use of in situ technology for the direct-expansion extrusion-cooking (DEEC) process. A recipe in the dry state consisting of 30% potato flour, 69% potato granules and 1 % salt, wherein a portion of the flour was replaced by SAC depending on the recipe, was extruded in a cooking extruder with an L/D=14 at a water content of 24% and an energy supply of 450 kJ/kg, and the 3 mm extrudate head was granulated and expanded at 150° C., wherein a water content of 13% was obtained. The Wo was then increased to the values specified in Table 2 with a moist atmosphere, and conditioned using the specified parameters. FIG. 2 shows the hydrolysis curves for the obtained expanded potato snack products. The KS-0 curve of a recipe without the use of SCA shows the hydrolysis behavior of the puffed state without ensuing conditioning. At an Ho=850%/h, the product KS-0 can therefore be digested exceedingly fast. This is because the extruded melt solidified almost completely in the amorphous state owing to the rapid water loss during the expansion. However, while the Ho could be lowered to values of down to about 500%/h in a subsequent conditioning process, water contents Wo>25% and times tk>30 min had to be used at temperatures Tk>70° C. A greater reduction during easily executed conditioning processes is obtained during the use of SCA. 20% SCA was used for product KS-1. A primarily amorphous state with Ho=770%/h was obtained nonetheless after puffing. THE water content that measured about 13% after puffing was then increased to Wo=17% via storage in an atmosphere with a high atmospheric humidity. Conditioning was then performed for 30 min at 125° C., so that Ho could be lowered to about 60%/h. The curves for the other KS samples correspond to samples with a reduced share of SCA and modified conditioning conditions. It is shown that a wide range between the very slow hydrolysis of native cornstarch up to the very rapid hydrolysis of the amorphous state can be achieved via in situ technology, and the specific characteristics can be explicitly set.

### EXAMPLE 3

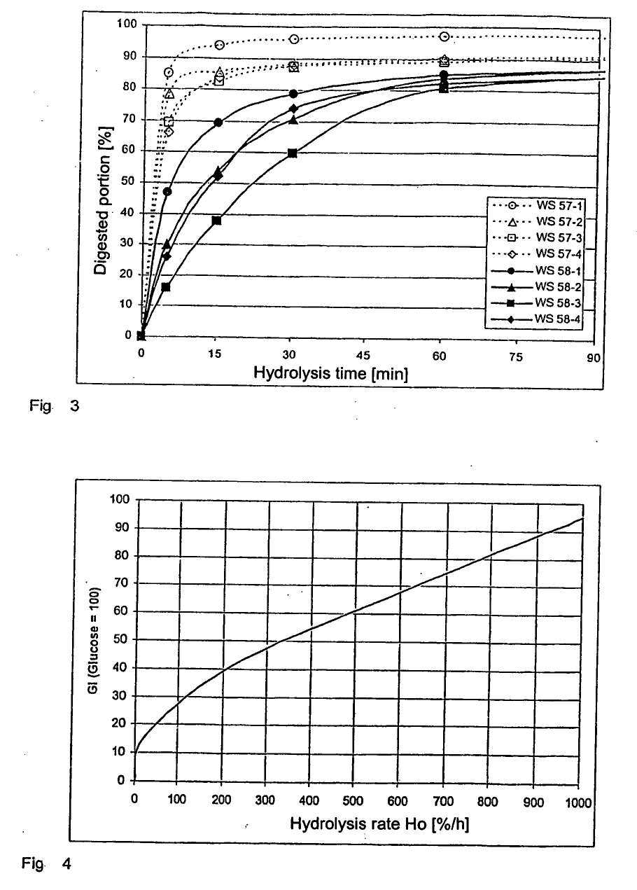

FIG. 3 shows the advantageous use of short-chain amylose (SCA). A process similar to the one described in Example 1 was carried out, but only cornstarch, water and, if necessary, a portion of SCA according to the data in Table 2 were added in the form of an aqueous solution. 0.5 mm films were pressed from the plasticized mass. The corresponding conditioning processes were conducted at the values for Wo given on Table 2 by holding the water content in the samples constant via packaging with saran wrap. At a percentage of 10% SCA, significant reductions in Ho were obtained for the products WS 58-1 to WS 58-4 under suitable conditioning conditions, and even without specific conditioning (WS 58-1), while the effect of comparable conditioning processes (adjusted to the somewhat higher water content Wo) is distinctly lower for the analogous products WS 57-1 to WS 57-4. Longer times tk are necessary for achieving greater reductions in Ho for products WS 57.

### EXAMPLE 4

These example illustrate the use of in situ technology for breads. White flour, wheat and salt were kneaded at a water content of 45% into a dough, the dough was left standing for 1 h, then baked for 45 min at 240° C. (BT 7-0). In an ensuing bread dough, a solution of SCA with 40° C. was added the preliminarily warmed pre-dough at 37° c, wherein a portion of the water was supplied via this solution to the dough preliminarily kneaded at a lower water content, so that the water content again measured 45%. After the dough had been completely and homogeneously kneaded, it was left standing for 1 h, and then baked for 45 min at 240° C., just as BT 7-0 (BT 7-2). In another bread dough, the process was the same as for BT 7-0, but a debranched enzyme (promozyme 400L, 400PUN/mI, Novozyme) was added with the water, and the pH was set to 5 with a 0.02 M citrate buffer. The enzyme concentration measured 0.5%. After left standing for one hour, the dough was heated to 60° C. in a microwave and kept at this temperature for 30 min. Baking then took place just as for BT 7-0. After the breads had cooled, they were left for 1 h at room temperature, and then samples were taken from the crumbs for hydrolysis purposes. The reference crumbs of the BT 7-0 had an initial hydrolysis rate Ho of 850%/h, while BT 7-1 yielded a value of 460%/h, and BT 7-2 a value of 530%/h for the crumbs. Therefore, a significant reduction could be achieved in the digestive rate. The organoleptic test revealed a distinctly higher crispiness of the fresh crust for BT 7-1 and BT 7-2 relative to BT 7-0. In order to analyze the development of crispiness, the breads were packaged in polyethylene pockets, so that the crumbs could moisten the crust. After 12 h, the crusts were analyzed. They became less soft than for BT 7-0 due to the moisture stress test.

### EXAMPLE 5

These examples illustrate the application of in situ technology for potato chips and Pringles. The basic starch was comprised of potato granules and potato flakes in a ratio of 8:2, 1.4% salt was added, the percentage of SCA relative to the starch as a whole was 20%, and Wo 32%. In mixtures with SCA, the SCA was mixed with water in a ratio of 1:2, and transferred to a solution at 160° C. in autoclaves for 5 min. This solution was then added with a temperature of about 95° C. to the at least partially thermoplastic mass of the basic starch, which had a mass temperature of 95-100° C. in a Brabender kneader at 110 RPM. The homogeneous mixture was then pressed into 0.5 mm thick films. Subsequently, the films were dried to a water content of 24%, and lightly expanded at 210° C. for 1 min, during which the water content was reduced to 15%. The samples were then further baked for 15 min at a high atmospheric humidity of around 95% at 130° C., after which they were dried for 3 min at 140° C. at a low atmospheric humidity. An Ho of 410%/h was reached (CP 5-1) at a percentage of SCA of 10%, 310%/h at 15% (CP 5-2), while conventional potato chips and Pringles have an Ho value of about 880%/h or 980%/h.

### EXAMPLE 6

These examples illustrate the application of in situ technology for potato flakes. Commercial potato flakes (Mifloc, Migros) were mixed with water heated to 70° C., and a 10% solution of SCA heated to 70° C. was added relative to the dry potato flakes, so that the water content of the mixture measured around 80%. The resultant paste was rolled into a thin film measuring about 0.2 mm, and dried at room temperature at an atmospheric humidity of 84% (KF-2). While the flakes had an Ho value of about 820%/h before treatment, the Ho after treatment was around 210%/h. The same treatment without adding SCA yielded an Ho of 620%/h (KF-1). As an alternative, the thin film of KF-2 was dried at 1 10° C. to a water content of 17% for KF-3, then conditioned at an atmospheric humidity of about 95% at 120° C. for 15 min, and subsequently dried. This yielded an Ho value of 540%/h.

Measuring Methods

Hydrolysis measurements: The hydrolysis measurements were performed based on the AOAC method 2002.02 using the resistant starch assay kit from Megazyme. In this case, amylase and amyloglucosidase are used for hydrolysis. This method and the kit from Megazyme were developed for the standardized determination of the percentage of resistant starch (RS) in starch-based products. By contrast, hydrolysis was stopped after specific time intervals, e.g., after 0.5, 1, 2, 3 h, etc., in order to obtain the percentage of digested starch by this point. Hydrolysis was conducted for 16 h per the norm to determine the RS percentage. A glass tube with substrate was used per hydrolysis period. It was shown that this procedure is more precise in comparison to aliquot sampling. After hydrolysis was stopped, the residue, i.e., the undigested starch, was subjected to sedimentation via centrifugation at 3000 g, dried and weighed (M1). The percentage of digested starch was obtained from the difference relative to the amount weighed in (M0) as (M1-M0)/M0. The results obtained in this way were identical to the determination of undigested starch via GOPOD (glucose oxidase-peroxidase aminoantipyrin), as comparative tests have revealed. In the case of substrates that contain other constituents in addition to starch and water, the soluble portion of non-starch constituents can be determined via reference tests without using amylases, and the non-soluble portion can be derived from the difference of the RS portion and M1 after 16 h. Therefore, starch fraction hydrolysis can be separated from the other procedures.

The described method for in vitro analysis of hydrolyzation kinetics can be correlated with known GI values. In this case, it was discovered that a good correlation exists between the initial hydrolysis rate Ho and the corresponding GI values. This is to be expected, since the majority of the starch is digested at rate Ho in most cases. FIG. 4 shows the correlation between Ho and GI (glucose=100). The GI value resulting from the figure for a specific Ho must be regarded as a guideline, since GI values measured in vivo most often exhibit a wide scatter. By contrast, in vitro hydrolysis rates can be determined much more easily and precisely, so that these values are relied upon in this application.

DSC measurements: The differential scanning calorimetry (DSC) measurements were performed with a Perkin-Elmer DSC-7. The device was calibrated with Indium. Sealed, stainless steel crucibles were used for the samples. The samples each weighed about 60 mg, the water content in the samples measured 70%, and the heating rate was 10° C./min. The respective peak temperature Tp of the melt endotherms for the crystalline percentage of the starch samples was determined.

Swelling: The samples of slowly digestible starch were swelled using 1 cm×1 cm platelets with a thickness of 0.5 mm. The platelets were here dried to a water content of 10% (weight G0), and then stored at room temperature for 24 h in deionized water (weight G1). The swelling level was found by dividing the weight of the swelled sample by the weight of the dried sample (0% water), as Q=G1/(0.9*G0). In puffed and porous samples, the unbound water was separated from the swelled sample to determine G1 through centrifugation at 3000 g.

TABLE 2

| | | | | | | | | |
|---|---|---|---|---|---|---|---|---|
| | Basic | SCA | Wo | | Ho | | Tp | Rs |
| No. | starch | [%] | [%] | Cond. | [%/h] | Q | [° C.] | [%] |

Example 1: Corn Flakes

| | | | | | | | | |
|---|---|---|---|---|---|---|---|---|
| WS 77-0 | Corn flour | 20 | 22 | 85° C./30 | 76 | 2.1 | 103 | 6 |
| | | | | min | | | | |
| WS 78-0 | Corn flour | 15 | 24 | 75° C./30 | 108 | 2.4 | 98 | 5 |
| | | | | min | | | | |
| WS 77-1 | Corn flour | 20 | 22 | 85° C./30 | 180 | 2.7 | 105 | 5 |
| | | | | min | | | | |
| WS 77-2 | Corn flour | 20 | 22 | 85° C./30 | 300 | 3 | 103 | 4 |
| | | | | min | | | | |
| WS 78-1 | Corn flour | 15 | 24 | 75° C./30 | 480 | 3.5 | 101 | 3 |
| | | | | min | | | | |

Example 2: Potato snack

| | | | | | | | | |
|---|---|---|---|---|---|---|---|---|
| KS-0 | Potato flour | 0 | 20 | none | 850 | >10 | — | 1 |
| KS 1 | Potato flour | 20 | 17 | 125° C./30 | 30 | 1.7 | 112 | 7 |
| | | | | m | | | | |
| KS 2 | Potato flour | 15 | 20 | 110° C./30 | 180 | 2.9 | 104 | 5 |
| | | | | m | | | | |
| KS 3 | Potato flour | 15 | 20 | 110° C./15 | 252 | 3.2 | 102 | 4 |
| | | | | m | | | | |
| KS 4 | Potato flour | 10 | 22 | 90° C./30 | 360 | 2.7 | 92 | 3 |
| | | | | min | | | | |
| KS 5 | Potato flour | 5 | 24 | 80° C./30 | 540 | 3.1 | 78 | 2 |
| | | | | min | | | | |

Example 3: Corn chips

| | | | | | | | | |
|---|---|---|---|---|---|---|---|---|
| WS 57-1 | Cornstarch | 0 | 27 | none | 1000 | >10 | — | 1 |
| WS 57-2 | Cornstarch | 0 | 27 | 50° C./30 | 950 | >10 | — | 1 |
| | | | | min | | | | |
| WS 57-3 | Cornstarch | 0 | 27 | 70° C./30 | 840 | 8 | 50 | 1 |
| | | | | min | | | | |
| WS 57-4 | Cornstarch | 0 | 27 | 25° C./1 d | 800 | 7 | 53 | 1 |
| WS 58-1 | Cornstarch | 10 | 24 | none | 600 | 5 | 64 | 3 |
| WS 58-2 | Cornstarch | 10 | 24 | 70° C./30 | 380 | 3.2 | 70 | 4 |
| | | | | min | | | | |
| WS 58-3 | Cornstarch | 10 | 24 | 90° C./30 | 320 | 3.1 | 94 | 4 |
| | | | | min | | | | |
| WS 58-4 | Cornstarch | 10 | 24 | 25° C./1 d | 190 | 2.8 | 92 | 5 |

Example 4: Chips & Pringles

| Potato chips | 0 | | | 880 | >10 | — | 1 |
|---|---|---|---|---|---|---|---|
| Potato Pringles | 0 | | | 980 | >10 | — | 1 |
| CP 5-1 | 10 | 15-10 | 130° C./15 | 410 | 3.2 | 91 | 3 |
| | | | m | | | | |
| CP 5-2 | 15 | 15-10 | 130° C./15 | 310 | 2.9 | 95 | 5 |
| | | | m | | | | |

Example 5: Bread

| | | | | | | | |
|---|---|---|---|---|---|---|---|
| BT 7-0 | Wheat flour | 0 | 45 | 25° C./1 h | 850 | — | 1 |
| BT 7-1 | Wheat flour | 10 | 45 | 25° C./1 h | 460 | 92 | 4 |
| BT 7-2 | Wheat flour | enzy | 45 | 25° C./1 h | 530 | 87 | 3 |

Example 6: Potato flakes

| Potato flakes | | 0 | | | 820 | — |
|---|---|---|---|---|---|---|
| KF-1 | Potato | 0 | 80-14 | 25° C./1 h | 620 | 69 |
| | flakes | | | | | |
| KF-2 | Potato | 10 | 80-14 | 25° C./1 h | 210 | 81 |
| | flakes | | | | | |
| KF-3 | Potato | 10 | 17-12 | 110° C./30 | 540 | 73 |
| | flakes | | | m | | |

| | | |
|---|---|---|
| Kellogg's Corn Flakes | 900 | |
| White baguette | 1000 | 1 |
| Whole grain bread | 530 | 9 |
| Pumpernickel | 220 | 17 |
| Native cornstarch | 64 | 3 |

SCA Short chain amylose, DP = 24
Wo Water content during conditioning
Cond. Conditioning
Ho Initial hydrolysis rate
Q Swelling level
Tp DSC melting point
RS Percentage of resistant starch/fiber

1. A slowly digestible, starch-containing foodstuff, characterized in that a starch network is generated in situ from an at least partially gelatinized state at least once during the manufacture of the foodstuff, this starch network is at least partially retained in the course of subsequent processing steps, and the DSC melting point of the crystallites in the starch network is >60° C., so that the initial hydrolysis rate (Ho) of the finished foodstuff is reduced by >10% by comparison to an analogous, conventionally manufactured foodstuff.

2. The foodstuff according to claim 1, characterized in that the hydrolysis rate (Ho) is constant or nearly constant for at least 10 min, and the constant hydrolysis rate measures <600%/h, if necessary.

3. The foodstuff according to claim 1, characterized in that the swelling level (Q) ranges from 1.1-5.

4. The foodstuff according to claim 1, characterized in that the DSC melting point of the crystallites in the starch network is >70° C.

5. The foodstuff according to claim 1, characterized in that the foodstuff has 1-95% short-chain amylose, and in particular that the foodstuff has network-linking mixed crystallites consisting of this amylose and the basic starch.

6. The foodstuff according to claim 1, characterized in that conditioning is performed at a conditioning temperature (Tk) and a water content (Wo), and performed at a difference Tk-To relative to the reference temperature ranging from 20-150, preferably 35-135, more preferably 50-120, most preferably 70-100, wherein the reference temperature (To) is provided as a function of water content (Wo) by the following correlation:
TABLE 1

| Wo | % | 10 | 15 | 20 | 25 | 30 | 35 | 40 | 45 | 50 | 55 | 60 | 65 | 70 | 80 | 90 |
|---|---|---|---|---|---|---|---|---|---|---|---|---|---|---|---|---|
| To | ° C. | 98 | 55 | 23 | −3 | — | — | — | — | — | — | — | — | — | — | — |
| | | | | | | 24 | 41 | 55 | 67 | 78 | 87 | 95 | 102 | 108 | 119 | 128 |

and the conditioning temperature (Tk in ° C.) is always >−10° C.

7. The foodstuff according to claim 6, characterized in that a temperature T=To +150° C., preferably T=To+135° C., more preferably T=To+120° C., most preferably T=To+100° C. is not exceeded following completed network formation at a later point in the manufacturing process, wherein To as a function of Wo is specified in the correlation between To and Wo provided in claim 6.

8. The foodstuff according to claim 1, characterized in that the foodstuff
a) is manufactured in the pellet-to-flakes extrusion-cooking process or a variant thereof, and conditioning to establish a starch network is performed before and/or during and/or after puffing-toasting; or
b) is manufactured in the direct-expansion extrusion-cooking process or a variant thereof, and conditioning is performed to establish a starch network after puffing-toasting; or
c) is manufactured out of flaking grits, and conditioning to establish a starch network is performed before flaking and/or during and/or after an ensuing procedural step; or
d) is manufactured in a baking process, wherein conditioning is performed during and/or upon finished baking and/or after baking.

9. The foodstuff according to claim 1, characterized in that the foodstuff is selected from the following groups: Flaked and puffed cereals, snacks, crisps and sticks; chips, Pringles, baked snacks, deep-fried snacks; biscuits, crackers, zwieback, bread, flaked and granulated potato, animal food, in particular pet food.

10. The foodstuff according to claim 1, characterized in that the foodstuff has an improved crispiness and/or a longer-lasting freshness.
